(19) United States
(12) Patent Application Publication
(10) Pub. No.: US 2024/0161640 A1
(43) Pub. Date: May 16, 2024

(54) CONTROL METHOD FOR HISTORY-BASED CODING EDUCATION SYSTEM

(71) Applicant: CODING & PLAY INC., Gangnam-gu Seoul (KR)

(72) Inventor: Jeong Seog LEE, Gwangju-si (KR)

(21) Appl. No.: 17/780,966

(22) PCT Filed: Sep. 10, 2021
(86) PCT No.: PCT/KR2021/012359

§ 371 Date: May 27, 2022

(30) Foreign Application Priority Data
Sep. 10, 2021 (KR) 10-2021-0120817

(51) Int. Cl. G09B 5/02; G06T 19/00

(52) U.S. Cl. CPC G09B 5/02; G06T 19/006; G06T 2200/24

(57) ABSTRACT

The present disclosure relates to a control method for a history-based coding education system, which includes: obtaining, by a first terminal, history stage information corresponding to user information from a server; obtaining, by the first terminal, an image input through a camera; identifying, by the first terminal, whether a marker corresponding to the history state information is included in the image; and outputting, by the first terminal, an augmented reality corresponding to the marker when the marker is included in the image.

### TECHNICAL FIELD

The present disclosure relates to a control method for a history-based coding education system, which conducts a coding education, and provides history information as a compensation for coding learning.

The control method for a history-based coding education system according to the present disclosure is capable implementing an augmented reality on an image which is obtained in real time in an electronic device in response to obtaining a specific or unspecific image through the electronic device of a learner.

### BACKGROUND ART

In the era of the Fourth Industrial Revolution, an early education on a coding education is becoming active for children, and this children's coding education was achieved through a combination of blocks to control virtual objects or real robots on a screen, and difficulty control has been executed according to the diversification of the block and the complexity of the combination method.

However, the difficulty control by the diversification of the block and the complexity of the combination method has a limit, and as a result, there has been a problem that the interest of children who conduct the learning can be easily lost.

Further, as a coding learning system is incorporated into a regular curriculum of compulsory educational institutions, the coding education is not simply limited to coding, but needs to be presented as a method for increasing a learning achievement according to a combination of existing regular courses.

### DISCLOSURE

### Technical Problem

The present disclosure provides a control method for a history-based coding education system, in which a conventional coding education combines an image or a story provided as a clear compensation with a history education, and performs the history education in addition to the coding education to enhance mutual learning achievement rates.

The objects to be solved by the present disclosure are not limited to the aforementioned objects, and other objects, which are not mentioned above, will be apparent to a person having ordinary skill in the art from the following description.

### Technical Solution

In order to solve the problem, according to an aspect of the present disclosure, a control method for a history-based coding education system including a server and a first terminal includes: obtaining, by a first terminal, history stage information corresponding to user information from a server; obtaining, by the first terminal, an image input through a camera; identifying, by the first terminal, whether a marker corresponding to the history state information is included in the image; and outputting, by the first terminal, an augmented reality corresponding to the marker when the marker is included in the image.

In this case, the outputting of the augmented reality corresponding to the marker may further include outputting at least one of history contents, a background image, and a virtual object corresponding to the marker, and, and outputting a plurality of blocks corresponding to the background image.

Additionally, the control method for the present disclosure may further include obtaining, by the first terminal, a user command for at least one block of the plurality of blocks; and controlling, by the first terminal, a movement of the virtual object based on the user command for the at least one block.

Preferably, the obtaining of, by the first terminal, the user command for at least one block of the plurality of blocks may further include obtaining history information corresponding to the user command for at least one block of the plurality of blocks, and outputting the history information to a predetermined coding area, identifying whether the history information corresponds to the history stage information, and deleting the history information and outputting a reinput request message when the history information does not correspond to the history stage information.

Preferably, the identifying of whether the history information corresponds to the history stage information may further include obtaining clear information corresponding to the history stage information from the server when the history information corresponds to the history stage information.

Preferably, the controlling of the movement of the virtual object based on the user command for the at least one block may further include outputting the clear information when the virtual object is positioned in a predetermined clear area.

In this case, the clear information may be history education data corresponding to the history stage information.

Additionally, the control method may further include: transmitting, by the first terminal, location information to the server in real time; obtaining, by the server, a pre-registered first relic image corresponding to the location information from the first terminal as a marker; obtaining, by the server, first history stage information corresponding to the first relic image; and outputting, by the first terminal, an augmented reality corresponding to the first relic image.

Additionally, the control method may further include: transmitting, by the server, hint information corresponding to a second relic image to the first terminal when the first terminal obtains clear information corresponding to the first relic image; and outputting, by the first terminal, the hint information.

In this case, the hint information may include an obtained point coordinate of the second relic image and a 3D relic image rotatable by the user command for the first terminal.

Additionally, the control method for the present disclosure may further include transmitting, by the first terminal, an object information update request for each weather to the server; obtaining, by the server, real-time weather information for each location from the other server; obtaining, by the server, real-time location information from the first terminal; matching, by the server, the real-time weather information for each location corresponding to the real-time location information; and updating, by the server, the virtual object based on a matching result.

Additionally, the control method for the present disclosure may further include: transmitting, by the first terminal, an object information update request for each location to the server; obtaining, by the server, pre-registered clothing information corresponding to the real-time location information; and updating, by the server, the virtual object based on the clothing information.

Additionally, the control method for the present disclosure may further include: obtaining, by the server, age information and gender information based on the user information; obtaining, by the server, difficulty information based on the age information; obtaining, by the server, interest topic information based on the gender information; obtaining, by the server, first history stage information corresponding to the difficulty information to the first terminal as recommendation information; and obtaining, by the server, education data corresponding to the interest topic information.

Preferably, the outputting of at least one of history contents, the background image, and the virtual object corresponding to the marker may further include: obtaining pre-used first character information based on clear history information; obtaining second character information corresponding to the age information and the gender information from the server; obtaining any one of the first character information, the second character information, and the third character information as the virtual object according to the user command.

Additionally, the control method for the present disclosure may further include: transmitting, by the server, the history stage information to a second terminal corresponding to the first terminal; transmitting, by the server, real-time location information corresponding to the first terminal to the second terminal; transmitting, by the server, access information corresponding to the first terminal to the second terminal; obtaining, by the server, teaching material information corresponding to the stage information to the second terminal; and limiting, by the server, the access of the first terminal, and storing a stage progress history corresponding to the first terminal when the second terminal transmits an access limit request to the first terminal to the server.

Details of the present disclosure will be included in the detailed description and the drawings.

### Advantageous Effects

According to the control method for a history-based coding education system of the present disclosure, there is an effect that in providing an augmented reality through marker recognition, virtual objects other than real robots are jointly provided to remove a spatial limit of the coding education, and history education data including an image and a 3D image is provided as a clear compensation for each stage corresponding to the coding education to enhance the mutual achievement rates for the coding education and the history education, and execute a complex education.

The effects of the present disclosure are not limited to the aforementioned effect, and other effects, which are not mentioned above, will be apparent to a person having ordinary skill in the art from the following disclosure.

### DESCRIPTION OF DRAWINGS

FIG. 1 is an implementation diagram of an augmented reality according to an exemplary embodiment of the present disclosure.

FIG. 2 illustrates a marker recognition method according to an embodiment of the present disclosure.

FIG. 3 illustrates a stage selection screen corresponding to the Three Kingdoms era of Korea according to an embodiment of the present disclosure.

FIG. 4 illustrates a stage selection screen corresponding to the Three Kingdoms era of China according to an embodiment of the present disclosure.

FIG. 5 illustrates a method for obtaining a relic as a marker according to an embodiment of the present disclosure.

FIG. 6 illustrates a method for obtaining hint information according to an embodiment of the present disclosure.

FIG. 7 is a system configuration diagram according to an embodiment of the present disclosure.

FIG. 8 is a basic flowchart according to an embodiment of the present disclosure.

FIG. 9 is a server configuration diagram according to an embodiment of the present disclosure.

### DESCRIPTION OF EXEMPLARY EMBODIMENTS

Advantages and features of the present disclosure, and methods for accomplishing the same will be more clearly understood from embodiments described in detail below with reference to the accompanying drawings. However, the present disclosure is not limited to the embodiments set forth below, and may be embodied in various different forms. The present embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims.

It is also to be understood that the terminology used herein is for the purpose of describing embodiments only and is not intended to limit the present disclosure. In the present disclosure, the singular form also includes the plural form, unless the context indicates otherwise. It is to be understood that the terms “comprise” and/or “comprising” used in the present disclosure does not exclude the presence or addition of one or more other components other than stated components. Like reference numerals refer to like components throughout the specification and “and/or” includes respective mentioned components and all one or more combinations of the components. Although the terms “first”, “second”, and the like are used for describing various components, these components are not confined by these terms. These terms are merely used for distinguishing one component from another component. Therefore, a first component to be mentioned below may be a second component in a technical concept of the present disclosure.

Unless otherwise defined, all terms (including technical and scientific terms) used in the present disclosure may be used as the meaning which may be commonly understood by the person with ordinary skill in the art, to which the present disclosure pertains. Further, terms defined in commonly used dictionaries should not be interpreted in an idealized or excessive sense unless expressly and specifically defined.

Further, the term “unit” or “module” used in the present disclosure means software and hardware components such as FPGA or ASIC and the “unit” or “module” performs predetermined roles. However, the “unit” or “module” is not a meaning limited to software or hardware. The “unit” or “module” may be configured to reside on an addressable storage medium and may be configured to play back one or more processors. Accordingly, as one example, the “unit” or “module” includes components such as software components, object oriented software components, class components, and task components, processes, functions, attributes, procedures, subroutines, segments of a program code, drivers, firmware, microcode, circuitry, data, databases, data structures, tables, arrays, and variables. Functions provided in the components and the “units” or “modules” may be combined into a smaller number of components and “units” or “modules” or further separated into additional components and “units” or “modules”.

“below”, “beneath”, “lower”, “above”, “upper”, etc., which are spatially relative terms may be used for easily describe a correlation between one component and other components as illustrated in the drawings. The spatially relative terms should be appreciated as terms including different directions of the components in using or operating in addition to the directions illustrated in the drawings. For example, when the component illustrated in the drawing is overturned, a component described as being “below” or “beneath” another component may be laid “above” another component. Accordingly, “below” or “beneath” which is an exemplary term may include both below and above directions. The component may be oriented even in the other direction, and as a result, the spatially relative terms may be interpreted according to the orientation.

In the present disclosure, a computer may mean all types of hardware devices including at least one processor, and according to an embodiment, the computer may be appreciated as a meaning including even a software component which operates in the hardware device. For example, the computer may be appreciated as a meaning including all of a smartphone, a tablet PC, a desktop computer, a notebook computer, and user clients and applications driven in each device.

Hereinafter, embodiments of the present disclosure will be described in detail with reference to the accompanying drawings.

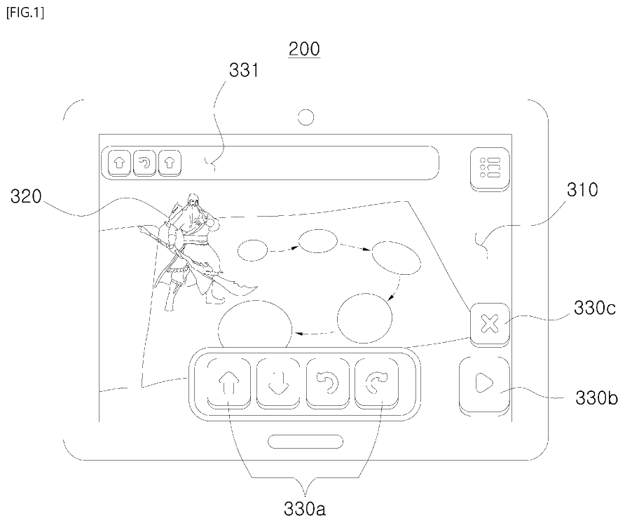

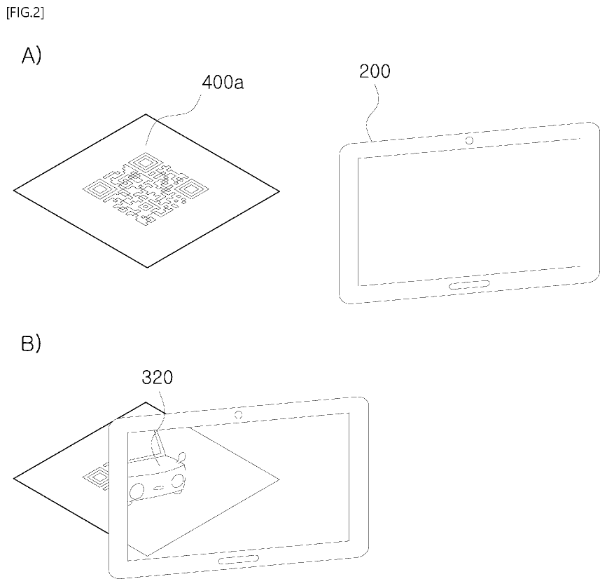

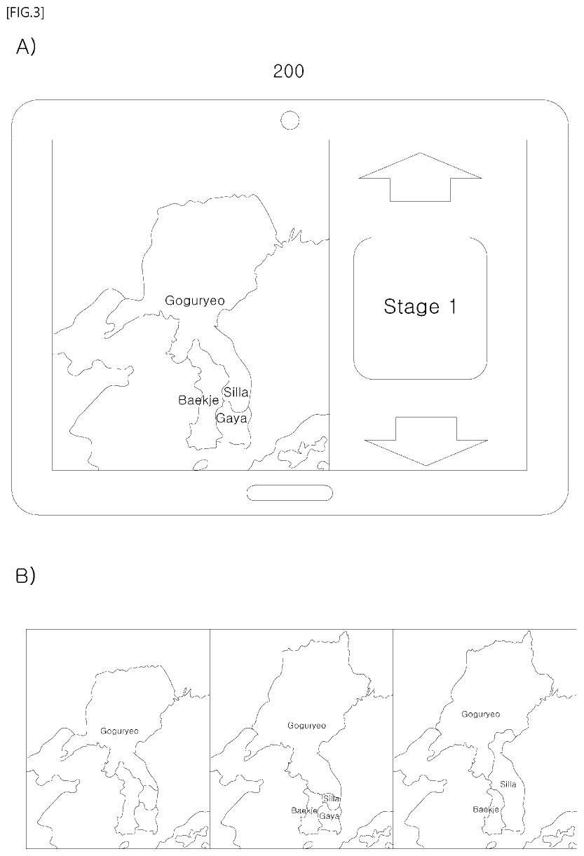

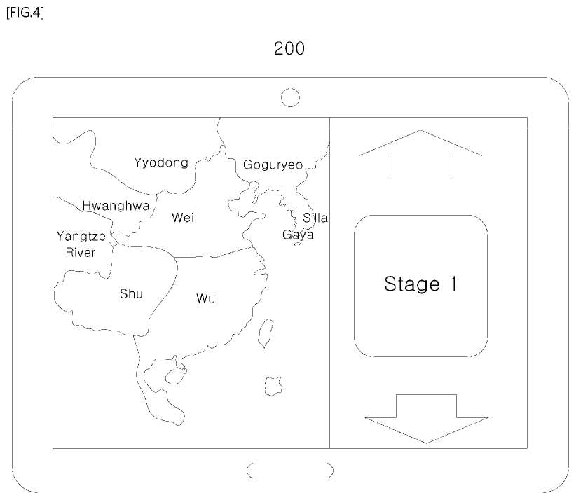

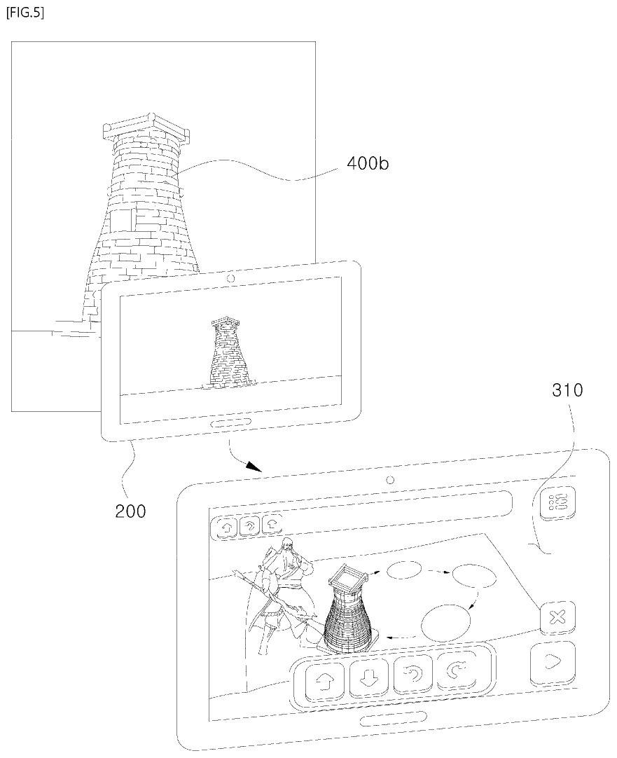

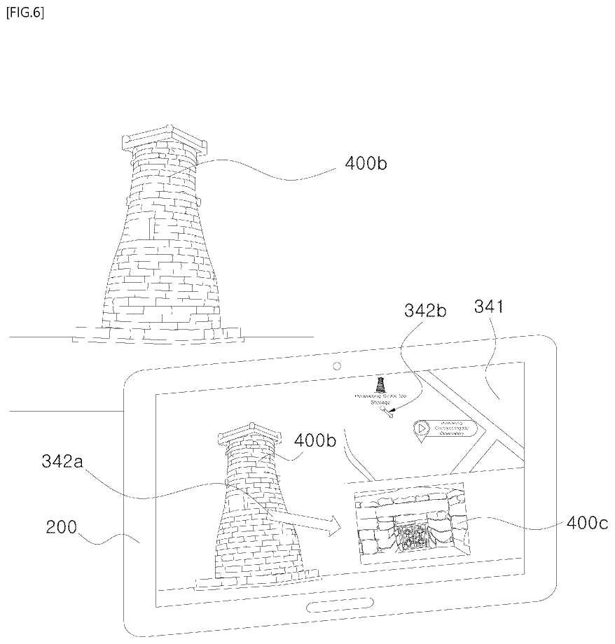

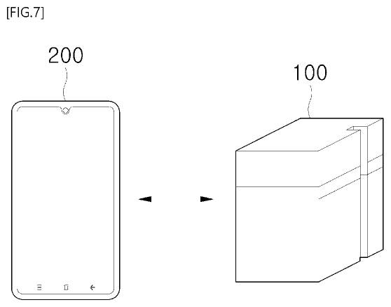

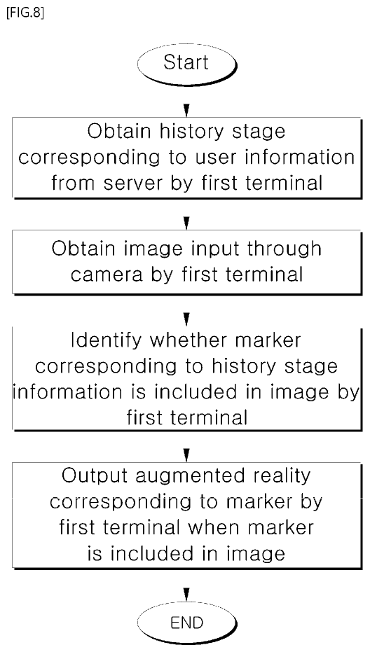

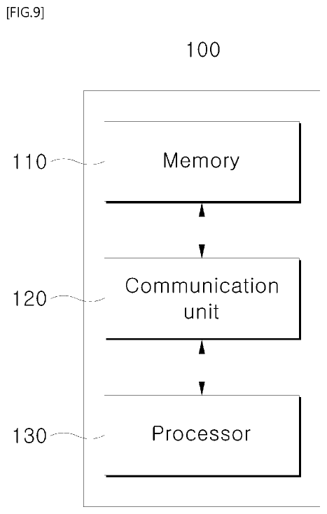

FIG. 1 is an implementation diagram of an augmented reality according to an exemplary embodiment of the present disclosure. FIG. 2 illustrates a marker recognition method according to an embodiment of the present disclosure. FIG. 3 illustrates a stage selection screen corresponding to the Three Kingdoms era of Korea according to an embodiment of the present disclosure. FIG. 4 illustrates a stage selection screen corresponding to the Three Kingdoms era of China according to an embodiment of the present disclosure. FIG. 5 illustrates a method for obtaining a relic as a marker according to an embodiment of the present disclosure. FIG. 6 illustrates a method for obtaining hint information according to an embodiment of the present disclosure. FIG. 7 is a system configuration diagram according to an embodiment of the present disclosure. FIG. 8 is a basic flowchart according to an embodiment of the present disclosure. FIG. 9 is a server configuration diagram according to an embodiment of the present disclosure.

In this case, a first terminal 200 and a second terminal which communicate with a server 100 may be electronic devices, and as an embodiment, the electronic device may include at least one of a smartphone, a tablet personal computer (PC), a mobile phone, a vide phone, an e-book reader, a desktop PC, a laptop PC, a netbook computer, a workstation, a server, a personal digital assistant (PDA), a portable multimedia player (PMP), an MP3 player, a mobile medical device, a camera, a wearable device, or an AI speaker.

As illustrated in FIG. 9, the server 100 may include a memory 110, a communication unit 120, and a processor 130.

The memory 110 may store various programs and data required for the operation of the server 100. The memory 110 may be implemented as a non-volatile memory 110, a volatile memory 110, a flash memory 110, a hard disk driver (HDD), or a solid state drive (SDD).

The communication unit 120 may communicate with en external device. In particular, the communication unit 120 may include various communication chips such as a WiFi chip, a Bluetooth chip, a wireless communication chip, an NFC chip, a low-power Bluetooth chip (BLE chip), etc. IN this case, the WiFi chip, the Bluetooth chip, and the NFC chip perform communications by an LAN scheme, a WiFi scheme, a Bluetooth scheme, and an NFC scheme, respectively. When the WiFi chip or the Bluetooth chip is used, various connection information such as an SSID and various information may be transmitted and received after communication connection by using the transmitted various connection information. The wireless communication chip means a chip that performs communication according to various communication standards such as IEEE, Zigbee, 3rd generation (3G), 3rd Generation Partnership Project (3GPP), Long Term Evolution (LTE), etc.

The processor 130 may control an overall operation of the server 100 by using various programs stored in the memory 110. The processor 130 may be constituted by a RAM, a ROM, a graphics processing unit, a main CPU, first to nth interfaces, and a bus. In this case, the RAM, the ROM, the graphics processing unit, the main CPU, the first to nth interfaces, etc., may be connected to each other through the bus.

The RAM stores an O/S and an application program. Specifically, when the server 100 is booted, the O/S may be stored in the RAM, and various application data selected by a user may be stored in the RAM.

A command set for system booting, etc., is stored in the ROM. When a turn-on command is input and power is thus supplied, the main CPU copies the O/S stored in the memory 110 to the RAM according to the command stored in the ROM, and executes the O/S to boot the system. When the booting is completed, the main CPU copies various application programs stored in the memory 110 to the RAM, and executes the application programs copied to the RAM to perform various operations.

The graphics processing unit generates a screen including various objects including items, images, texts, etc., by using an operating unit (not illustrated) and a rendering unit (not illustrated). Here, the operating unit may be a component that computes attribute values including coordinate values, forms, sizes, colors, etc., in which respective objects are to be displayed according to a layout of the screen. In addition, the rendering unit may be a component that generates a screen having various layouts including the object based on the attribute values computed by the operating unit. Here, the screen generated by the rendering unit may be displayed in a display area of a display.

The main CPU accesses the memory 110 and performs the booting by using the OS stored in the memory 110. In addition, the main CPU performs various operations by using various programs, contents, data, etc., stored in the memory 110.

The first to nth interfaces are connected to various components described above. One of the first to nth interfaces may also become a network interface connected to an external device through a network.

As illustrated in FIG. 8, the control method for a history-based coding education system according to the present disclosure includes obtaining, by the firsts terminal 200, history storage information corresponding to user information from the server 100, obtaining, by the first terminal 200, an image input through a camera, identifying, by the first terminal 200, whether a marker corresponding to the history state information is included in the image, and outputting, by the first terminal 200, an augmented reality 310 corresponding to the marker when the marker is included in the image.

In the obtaining of the history stage information corresponding to the user information from the server 100 by the first terminal 200, the first terminal 200 may be an electronic device corresponding to a student who receives a history-based coding education, the history stage information may be information to which difficulty level information and era information are reflected according to a coding education learning stage of the student corresponding to the first terminal 200, and include learning information for conducting the coding education, such as coding correct answer information, clear area information, clear information, etc.

In this case, it is possible to obtain the user information by accessing the server 100 by the first terminal 200 through a social account.

As an embodiment, as illustrated in FIGS. 3 and 4, the era information may be information on any one stage (e.g., stage 1, stage 2, the Three Kingdoms era of Goguryeo, Baekje, and Silla of the Korean Peninsula, the Three Kingdoms era of Wei, Shu, and Wu of China) among a plurality of stages according to a territorial change for each era, and as a result, stage 2 corresponding to stage 1 may include territorial change information which occurs after a time corresponding to stage 1.

As an embodiment, when the history-based coding education is conducted on the background of the Three Kingdoms era of Goguryeo, Baekje, and Silla illustrated in FIG. 3, Korean Peninsula Stage 1 outputs, as a background image, a pre-registered representative terrain in a golden age of Baekje, the 4^{th} century, Korean Peninsula Stage 2 outputs, as the background image, the pre-registered representative terrain in the golden age of Goguryeo, the 5^{th} century, Korean Peninsula Stage 3 outputs, as the background image, the pre-registered representative terrain in the golden age of Silla, the 6^{th} century, and Korean Peninsula Stage 4 outputs, as the background image, a three-kingdom unification terrain by Silla in the end of the 6^{th} century.

Specifically, the Korean Peninsula Stages 1, 2, 3, and 4 may further implement detailed Korean Peninsula stages based on a main Korean Peninsula stage, and the background image may include person characters (e.g., Wang Gun, Gyeon Hwon, Gwanggaeto Great, Jinheung King, etc.), representative terrains (e.g., respective terrains of Goguryeo, Baekje, and Silla illustrated in FIG. 3, local images where major battles occurred, etc.), and building images, which are configured based on a central incident.

In this case, the terrain change information of Goguryeo, Baekje, and Silla may include capital coordinate change information for each kingdom, border change information centered on the Han River, battle information corresponding to a border change, and trade route information according to a terrain change.

Further, the detailed Korean Peninsular stage may be implemented based on a main incident which occurs between the main Korean Peninsular stages, and specifically, a detailed Korean Peninsular stage having Korean Peninsular Stage 2 as the main Korean Peninsular stage may be a Silla-Baekje alliance stage (the year of 433).

As another embodiment, when the history-based coding education is conducted on the background of the Three Kingdoms era of Wei, Shu, and Wu illustrated in FIG. 4, China Stage 1 may be a three kingdoms establishment stage (the year of 219), China Stage 2 may be a Later Han destroy stage (the year of 220), China Stage 3 may be a three kingdoms establishment collapse stage (the year of 263, the destroy of Shu Han), China Stage 4 may be Sound Qin founding stage (the year of 265, the destroy of Wei), and China Stage 5 may be a China unification stage (the year of 280, the destroy of Wu).

Specifically, China Stages 1, 2, 3, 4, and 5 may further implement detailed China stages based on a main China stage, and the background image may include person characters (e.g., Liu Bei, Guan Yu, and Zhang Fei, Sun Quan, Sima Yi, Jeoktoma, etc.), representative terrains (e.g., respective terrains of Wui, Shu, and Wu illustrated in FIG. 4, local images where major battles occurred, etc.), and building images, which are configured based on the central incident.

In this case, the terrain change information of Wui, Shu, and Wu may include monarch change information for each kingdom, prime minister change information for each kingdom, power-holder change information for each kingdom, battle information corresponding to a border change, and trade route information according to the terrain change.

Further, the detailed China stage may be implemented based on the main incident which occurs between the main China stages, and specifically, a detailed China stage having China Stage 1 as the main China stage may be implemented based on battle information, trade item change information, and major person death information which occur between the year of 219 and the year of 220.

Preferably, in the obtaining of the image input through the camera by the first terminal 200 and the identifying of whether the marker corresponding to the history stage information is included in the image by the first terminal 200, the first terminal 200 may obtain a market (e.g., a teaching material image, an electronic code 400a illustrated, a relic image, etc.) in an image obtained in real time through the camera of the first terminal 200 as illustrated in FIGS. 2A and 5.

In this case, the marker may be authentication information pre-registered in the server 100, and the student corresponding to the first terminal 200 authenticates the marker in the server 100 through the first terminal 200 to obtain information for outputting the augmented reality 310 corresponding to the history stage information from the server 100.

When the marker is included in the image in the outputting of the augmented reality 310 corresponding to the marker by the first terminal 200, the first terminal 200 may implement the augmented reality 310 corresponding to the marker as illustrated in FIGS. 1, 2B, and 5.

As an embodiment, when the first terminal 200 designates the marker by obtaining a user command, the obtaining of the image input through the camera may further include obtaining a first location value which is a coordinate of the marker in the image, obtaining a second location value corresponding to the first location value, and obtaining a projection area of the augmented reality 310 based on the first location value and the second location value, and the outputting of the augmented reality 310 corresponding to the marker may further include outputting the augmented reality 310 based on the projection area.

In this case, the outputting of the augmented reality 310 corresponding to the marker may further include outputting at least one of history contents, a background image, and a virtual object 320 corresponding to the marker, and outputting a plurality of blocks 330a, 330b, and 330c corresponding to the background image.

Specifically, as illustrated in FIG. 1, when the marker is a teaching material image including a movement route of the virtual object 320, the augmented reality 310 may be implemented centered on the teaching material image which is the marker, and a size of the virtual object 320 is adjusted in real time based n the size of the teaching material image obtained in real time to implement a perspective in the first terminal 200.

As illustrated in FIG. 1, a start point, a first point, a second point, a third point, and an arrival point represented by a circle exist in the teaching material image, and a movement direction between respective points which exist between the start point and the arrival point may be guided with direction indication information (e.g., arrows).

The plurality of blocks 330a, 330b, and 330c may include a command block 330a capable of inputting the coding command, a reproduction block 330b indicating object movement according to history information 331 input by the command block, and a delete block 330c capable of resetting the history information 331, and in this case, the command block may be constituted by a plurality of command blocks according to command contents.

As an embodiment, as illustrated in FIG. 2, the marker may be an electronic code 400a image, and as illustrated in FIG. 5, the marker may be the relic image.

As a result, the control method for the present disclosure may further include obtaining, by the first terminal 200, the user command for at least one block of the plurality of blocks 330a, 330b, and 330c, and controlling, by the first terminal 200, the movement of the virtual object 320 based on the use command for at least one block.

Preferably, the obtaining of the user command for at least one block of the plurality of blocks 330a, 330b, and 330c may further include obtaining the history information 331 corresponding to the user command for at least one block of the plurality of blocks 330a, 330b, and 330c, and outputting the history information 331 to a predetermined coding area, identifying whether the history information 331 corresponds to the history stage information, and deleting the history information 331 and outputting a reinput request message when the history information 331 does not correspond to the history stage information.

In the obtaining of the history information 331 corresponding to the user command for at least one block of the plurality of blocks 330a, 330b, and 330c, and outputting the history information 331 to the predetermined coding area, the coding area may be output to an area which does not invade a movement range of the virtual object 320 in the augmented reality 310 output on the screen of the first terminal 200, and the first terminal 200 may obtain an input of the student corresponding to the command block 330a as the user command, and output the obtained user command as the history information 331, as illustrated in FIG. 1.

As an embodiment, the identifying of whether the history information 331 corresponds to the history stage information may further include obtaining, by the first terminal 200, location information of the virtual object 320 on the augmented reality 310, obtaining, by the first terminal 200, movement section information based on the location information of the virtual object 320, identifying, by the first terminal, whether the history information 331 and the movement section information correspond to each other, and identifying, by the first terminal 200, whether the history information 331 and the history stage information correspond to each other according to whether the history information 331 and the movement section information corresponding to each other.

As an embodiment, the deleting the history information 331 and outputting the reinput request message when the history information 331 does not correspond to the history stage information may further include classifying, by the first terminal 200, history information 331 not corresponding to the history stage information into error history information, detecting, by the first terminal 200, an error block in the error history information, converting, by the first terminal, an image of the command block corresponding to the error block into a red color, obtaining a correct answer block corresponding to the error block, and converting, by the first terminal 200, the image of the command block corresponding to the correct answer block into a green color.

Specifically, the first terminal 200 outputs the reinput request message and outputs the correct answer block and the error block as images having different colors to provide wrong answer information (location information of the error block) and the correct answer information (location information of the correct answer block) to the student corresponding to the first terminal 200.

As an embodiment, the identifying of whether the history information 331 corresponds to the history stage information may further include locating the virtual object at the start point and resetting the history information 331 when the virtual object 320 moves out of the augmented reality 310.

Additionally, the identifying of whether the history information 331 corresponds to the history stage information may further include obtaining the clear information corresponding to the history stage information from the server 100 when the history information 331 corresponds to the history stage information, and the controlling of the movement of the virtual object 320 based on the user command for at least one block may further include outputting the clear information when the virtual object 320 is positioned in a predetermined clear area.

In this case, the clear information may be history education data corresponding to the history stage information.

Specifically, when the virtual object 320 moves on the augmented reality and is positioned at the arrival point which is the clear area according to the history information 331, the first terminal 200 may output a pop-up image (e.g., a congratulatory message, an image in which a firework is exploded, etc.), a pre-registered operation (e.g., an operation of running in place with a smiley face, an operation of moving one circle centered on the arrival point, etc.), and the history education data, which correspond to the clear information.

In this case, as an embodiment, the history education data may include an animation for a background knowledge in which three kingdoms are formed by Goguryeo, Baekje, and Silla when the history stage information is Korean Peninsula Stage 1, and information corresponding to an image selected through the first terminal 200 may be output and provided as the pop-up image according to predetermined tagging of images output to the animation.

For example, when a character corresponding to Gwanggaeto King is selected on the animation, the first terminal 200 may temporarily stop reproduction of the animation and the character corresponding to the Gwanggaeto King pops up to reproduce a recording file corresponding to person information such as a birth myth, a major achievement, etc.

As another embodiment, the history education data may include an animation for a background knowledge in which three kingdoms are formed by Wui, Shu, and Wu when the history stage information is China Stage 1, and information corresponding to an image selected through the first terminal 200 may be output and provided as the pop-up image according to predetermined tagging of images output to the animation.

For example, when a word brother-in-law is output while Yubi, Guan Yu, and Zhang Fei appear jointly, an animation for Oath of the Peach Garden may be additionally output.

Additionally, the control method for the present disclosure may further include transmitting, by the first terminal 200, location information to the server 100 in real time, obtaining, by the server 100, a pre-registered first relic image 400b corresponding to the location information from the first terminal 200 as the marker, obtaining, by the server 100, first history stage information corresponding to the first relic image 400b, and outputting, by the first terminal 200, the augmented reality 310 corresponding to the first relic image 400b.

As an embodiment, the obtaining of the pre-registered first relic image 400b corresponding to the location information from the first terminal 200 as the marker by the server 100 may further include obtaining, by the server 100, relic information positioned in a predetermined area with the first terminal as a central coordinate based on the location information of the first terminal 200, obtaining, by the server 100, a real-time image from the first terminal 200, and obtaining, by the server 100, the first relic image 400b as the marker based on the real-time image and the relic information.

Specifically, when the relic information which may be obtained with the first relic image 400b may be limited according to the location of the first terminal 200, and the first relic image 400b is obtained as the marker, and as a result, the first terminal 200 may output the augmented reality 310 based on the pre-registered history information corresponding to the first relic image 400b.

In this case, the first relic image 400b may be obtained from an image including at least any one of a building (e.g., a castle, a palace, an old house, etc.) a historical site, an exhibition facility (e.g., a museum, a gallery, a theme facility, a fair, etc.), an exhibited item, and a historical relic.

Specifically, as illustrated in FIGS. 5 and 6, the first relic image 400b may be a history related building image such as Chemseongdae, Seokbingo, and Baekje Castle, and besides, may be a stone image such as Memorial Stone for Gwanggaeto King, a metal image such as Gilt-bronze Mitreya in Meditation, a guide sign board image of a historical site such as Battle of Red Cliffs historical site of Yangtze River.

In the obtaining of the first history stage information corresponding to the first relic image 400b by the server 100 and the outputting of the augmented reality 310 corresponding to the first relic image 400b by the first terminal 200, first history stage information may be stage information configured based on historical information where a relic corresponding to the first relic image 400b is generated or historical information related to the relic.

Additionally, the clear information corresponding to the first relic image 400b may include a 3D model image corresponding to the first relic image, and in this case, the 3D model image rotates in all direction within the augmented reality 310 output to the first terminal 200.

Additionally, the control method for the present disclosure may further include transmitting, by the server 100, hint information 341, 342a, and 342b corresponding to a second relic image 400c to the first terminal 200 and outputting, by the first terminal 200, the hint information 341, 342a, and 342b, when the first terminal 200 obtains the clear information corresponding to the first relic image 400b.

In this case, the hint information 341, 342a, and 342b may include an obtained point coordinate of the second relic image 400c and a 3D relic image rotatable by the user command for the first terminal 200.

As an embodiment, as illustrated in FIG. 6, the outputting of the hint information 341, 342a, and 342b may further include outputting, by the first terminal 200, map information 341 corresponding to the first relic image 400b and the second relic image 400c, outputting, by the first terminal 200, guide information based on the location information of the first terminal 200 and the map information 341, outputting, by the first terminal 200, a 2D image or a 3D relic image of the second relic image 400c, and outputting, by the first terminal 200, movement guide information based on real-time location information of the first terminal 200.

In this case, the obtained point coordinate of the second relic image 400c may match the map information 341, and the movement guide information may be classified into a first direction indicator 342a and a second direction indicator 342b as illustrated in FIG. 6.

As an embodiment, the first direction indicator corresponds to rotation information when the second relic image 400c corresponding to the location information is not obtained and the second direction indicator corresponds to direction information in the map information 341 of the second relic image 400c corresponding to the location information.

Specifically, the first direction indicator may be information obtained by visually outputting a result of calculating an angle and a distance between a direction which the student corresponding to the first terminal 200 views and the obtained point coordinate of the second relic image 400c based on the image which the first terminal 200 obtains through the camera in real time, and the second direction indicator may be information obtained by outputting the first direction indicator in the map information.

Additionally, when the first terminal 200 obtains the second relic image 400c as the marker, an algorithm corresponding to the first relic image 400b is implemented by converting the second relic image 400c into the first relic image 400b, and as a result, a new second relic image 400c and hint information 341, 342a, and 342b corresponding to the new second relic image 400c may be generated.

As an embodiment, the control method for the present disclosure may further include transmitting, by the first terminal 200, obtained history information related to obtaining of the relic image to the server 100, calculating, by the server 100, a non-obtaining period of the relic image based on the obtained history information, and transmitting, by the server 100, clear history information corresponding to the obtained history information to the first terminal 200 when the non-obtaining period exceeds a predetermined period.

In this case, the clear history information may include the history information 331 and the clear information of the augmented reality 310 implemented by using the relic image as the marker, and the first terminal 200 receives the clear history information from the server 100, and as a result, the student corresponding to the first terminal 200 may perform a review through a moving picture for coding learning details for at least one relic image cleared thereby and summary data for history learning details.

As another embodiment, the control method for the present disclosure may further include obtaining, by the first terminal 200, a first history time corresponding to the first relic image 400b and a second history time corresponding to the second relic image 400c when obtaining the clear information corresponding to the second relic image 400c, obtaining, by the first terminal 200, intermediate stage information from the server 100 based on the first history time and the second history time, outputting, by the first terminal 200, the augmented reality 310 corresponding to the intermediate stage information, and outputting, by the first terminal 200, intermediate history information when obtaining the clear information corresponding to the intermediate stage information.

Specifically, it is possible to obtain the augmented reality corresponding to the intermediate stage information without a separate marker, and the intermediate history information may be history education data including the animation, the relic image, the person information, etc., configured based on a historical fact which occurs between the first history time and the second history time.

As an embodiment, the transmitting of the hint information 341, 342a, and 342b corresponding to the second relic image 400c to the first terminal 200 by the server 100 may further include outputting, by the first terminal 200, a coding game corresponding to the hint information 341, 342a, and 342b, and the outputting of the hint information 341, 342a, and 342b by the first terminal 200 may further include obtaining, by the first terminal 200, game clear information corresponding to the coding game and outputting, by the first terminal 200, the hint information 341, 342a, and 342b corresponding to the game clear information.

As an embodiment, the control method for the present disclosure may further include transmitting, by the server 100, a store pass corresponding to the location information of the first terminal 200 to the first terminal 200 when the first terminal 200 obtains the clear information corresponding to the first relic image 400b.

Additionally, the control method for the present disclosure may further include transmitting, by the first terminal 200, an object information update request for each weather to the server 100, obtaining, by the server 100, real-time weather information for each location from the other server 100, obtaining, by the server 100, real-time location information from the first terminal 200, matching, by the server 100, real-time weather information for each location corresponding to the real-time location information, and updating, by the server 100, the virtual object 320 based on a matching result.

For example, when the real-time weather information for each location includes a shower, a raincoat image, an umbrella image, a rain cloud image, etc., match the virtual object 320 may be output jointly, and when the real-time weather information for each location includes heat wave warnings, a swimsuit image, a fan image, an electric fan image, a sunglasses image, etc., may match the virtual object 320 and may be output jointly, and when the real-time weather information for each location includes fine dust information, a mask image may be output jointly or a motion of the virtual object 320 which coughs may be output.

Further, the control method for the present disclosure may further include transmitting, by the first terminal 200, the object information update request for each location to the server 100, obtaining, by the server 100, pre-registered clothing information corresponding to the real-time location information, and updating, by the server 100, the virtual object 320 based on the clothing information.

Specifically, according to the clothing information corresponding to the location information, a dress image or an ornament image of the virtual object 320 is enabled to be changed, and as a result, the dress image of the virtual object 320 may be changed to a dress of a current kingdom and an old kingdom (e.g. Goguryeo, Baekje, Silla, Wei, Shu, Wu, etc.) corresponding to the location information.

Additionally, the control method for the present disclosure may further include obtaining, by the server 100, age information and gender information based on user information, obtaining, by the server 100, difficulty information based on the age information, obtaining, by the server 100, interest topic information based on the gender information, transmitting, by the server 100, the history stage information corresponding to the difficulty information to the first terminal 100 as recommendation information, and obtaining, by the server 100, education data corresponding to the interest topic information.

Specifically, when compensation is data that is not interested, a motivation for a game progress may be reduced, so education data having a topic corresponding to the interest topic information obtained based on the user information is provided to increase a learning concentration on the history based coding education, and induce the resulting high learning achievement.

To this end, a hero viewpoint is diversified into an object, a mythical figure, an animal, a mythical animal, a woman, a man, an adult, a child, a king, an aristocrat, a subject, etc., and the topic is subdivided into food, clothing, and shelter, a terrain change, a composition of power, a war, a myth, a religion, et., to configure the animation according to the hero viewpoint and the topic based on a keyword corresponding to the interest topic information and provide the animation as the education data.

Preferably, the outputting of at least one of the history contents, the background image, and the virtual object 320 corresponding to the marker further includes obtaining pre-used first character information based on the clear history information, obtaining second character information corresponding to the age information and the gender information from the server 100, obtaining new registered third character information from the server 100, and obtaining any one of the first character information, the second character information, and the third character information from the virtual object 320 according to the user command, and as a result, the character information corresponding to the virtual object 320 may be changed by obtaining the user command by the first terminal 200.

Additionally, in the control method for the present disclosure, the coding correct answer information among the learning information including the history stage information may correspond to the difficulty information.

As an embodiment, the difficulty information may be divided into stage 1 to stage 10, and specifically, the coding correct answer information may be constituted mainly by a coding command using method in response to stage 1, mainly by simple repetition and sequential execution of the coding command in response to stage 2, mainly by sequential execution of the coding learning contents in response to stage 3, mainly by a coding condition statement in response to stage 4, mainly by sequential execution of free coding and the coding command in response to stage 5, mainly by a repetition statement of the coding learning contents in response to stage 6, mainly by a debugging and transform method in response to stage 7, mainly by sequential execution of the coding learning contents in response to stage 8, mainly by the repetition statement of the coding learning contents in response to stage 9, and mainly by a debugging and compression method in response to stage 10.

For example the difficulty information may be constituted by (front, rear, left turn, and right turn) in response to stage 1, by (front, rear, and eye color conversion of the virtual object 320) in response to stage 2, by (front, rear, left turn, right turn, and eye color conversion of the character) in response to stage 3, by (front, rear, left turn, right turn, and 45-degree rotation) in response to stage 4, by (front, rear, left turn, right turn, 45-degree rotation, and eye color conversion of the character) in response to stage 5, (front, rear, left turn, right turn, and number 3) in response to stage 6, by (front, rear, left turn, right turn, 45-degree rotation, eye color conversion of the character, and number 3) in response to 7, by (front, rear, left turn, right turn, 45-degree rotation, 30-degree rotation, and 60-degree rotation) in response to step 8, by (front, rear, left turn, right turn, 40-degree rotation, 30-degree rotation, 60-degree rotation, number 5, and number 6) in response to stage 9, and by (130-degree rotation and number 11) in response to stage 10.

Additionally, the control method for the present disclosure may further include transmitting, by the server 100, the history stage information to the second terminal corresponding to the first terminal 200, transmitting, by the server 100, the real-time location information corresponding to the first terminal 200 to the second terminal, transmitting access information corresponding to the first terminal 200 to the second terminal, transmitting, by the server 100, teaching material information corresponding to the stage information to the second terminal, and limiting, by the server 100, the access of the first terminal 200, and storing a stage progress history corresponding to the first terminal 200 when the second terminal transmits an access limit request to the first terminal 200 to the server 100.

Specifically, the second terminal may be an electronic device of a protector of the student corresponding to the first terminal 200, and by the stages, it is possible for the protector corresponding to the second terminal to obtain progress situation information of the history based coding education of the first terminal 200 in real time.

Meanwhile, the processor 130 may include one or more cores (not illustrated) and a graphic processing unit (not illustrated) and/or a connection passage (e.g., a bus, etc.) for transmitting and receiving a signal to and from another component.

The processor 130 according to an embodiment executes one or more instructions stored in the memory 110 to perform the method described in relation to the present disclosure.

For example, the processor 130 may obtain new learning data by executing one or more instructions stored in the memory 110, test the obtained new learning data, extract first learning data in which labeled information is obtained with a predetermined first reference value or more as a result of the test, delete the extracted first learning data from the new learning data, and learn the learned model again by using the new learning data from which the extracted learning data is deleted.

Meanwhile, the processor 130 may further include a random access memory (RAM) (not illustrated) and a read-only memory (ROM) (not illustrated) temporarily and/permanently a signal (or data) processed in the processor 130. Further, the processor 130 may be implemented as a form of a system on chip (SoC) including at least one of the graphic processing unit, the RAM, and the ROM.

The memory 110 may store programs (one or more instructions) for processing and controlling the processor 130. The programs stored in the memory 110 may be divided into a plurality of modules according to the function.

Steps of a method or algorithm described in association with the embodiments of the present disclosure can be directly implemented as hardware, or implemented as a software module executed by the hardware, or a combination thereof. The software module may be configured to include a random access memory (RAM), a read only memory (ROM), an erasable programmable ROM (EPROM), an electrically erasable programmable ROM (EEPROM), a flash memory, a hard disk, a removable disk, a CD-ROM, or any type of computer-readable recording medium well-known in the art to which the present disclosure pertains.

The components of the present disclosure may be implemented as a program (or application) and stored in the medium to be executed in combination with a computer which is the hardware. The components of the present disclosure may be executed by software programming or software elements, and similarly thereto, the embodiment includes a data structure, processes, routines, or various algorithms implemented by a combination of other programming components to be implemented by a programming or scripting language such as C, C++, Java, assembler, etc. Functional aspects may be implemented by an algorithm executed by one or more processors.

Hereinabove, the embodiments of the present disclosure have been described with the accompanying drawings, but it can be understood by those skilled in the art that the present disclosure can be executed in other detailed forms without changing the technical spirit or requisite features of the present disclosure. Therefore, it should be understood that the above-described embodiments are illustrative in all aspects and do not limit the present disclosure.

### MODE FOR INVENTION

In order to solve the problem, according to an aspect of the present disclosure, a control method for a history-based coding education system including a server and a first terminal includes: obtaining, by a first terminal, history stage information corresponding to user information from a server; obtaining, by the first terminal, an image input through a camera; identifying, by the first terminal, whether a marker corresponding to the history state information is included in the image; and outputting, by the first terminal, an augmented reality corresponding to the marker when the marker is included in the image.

In this case, the outputting of the augmented reality corresponding to the marker may further include outputting at least one of history contents, a background image, and a virtual object corresponding to the marker, and, and outputting a plurality of blocks corresponding to the background image.

Additionally, the control method for the present disclosure may further include obtaining, by the first terminal, a user command for at least one block of the plurality of blocks; and controlling, by the first terminal, a movement of the virtual object based on the user command for the at least one block.

Preferably, the obtaining of, by the first terminal, the user command for at least one block of the plurality of blocks may further include obtaining history information corresponding to the user command for at least one block of the plurality of blocks, and outputting the history information to a predetermined coding area, identifying whether the history information corresponds to the history stage information, and deleting the history information and outputting a reinput request message when the history information does not correspond to the history stage information.

Preferably, the identifying of whether the history information corresponds to the history stage information may further include obtaining clear information corresponding to the history stage information from the server when the history information corresponds to the history stage information.

Preferably, the controlling of the movement of the virtual object based on the user command for the at least one block may further include outputting the clear information when the virtual object is positioned in a predetermined clear area.

In this case, the clear information may be history education data corresponding to the history stage information.

Additionally, the control method may further include: transmitting, by the first terminal, location information to the server in real time; obtaining, by the server, a pre-registered first relic image corresponding to the location information from the first terminal as a marker; obtaining, by the server, first history stage information corresponding to the first relic image; and outputting, by the first terminal, an augmented reality corresponding to the first relic image.

Additionally, the control method may further include: transmitting, by the server, hint information corresponding to a second relic image to the first terminal when the first terminal obtains clear information corresponding to the first relic image; and outputting, by the first terminal, the hint information.

In this case, the hint information may include an obtained point coordinate of the second relic image and a 3D relic image rotatable by the user command for the first terminal.

Additionally, the control method for the present disclosure may further include: transmitting, by the first terminal, an object information update request for each weather to the server; obtaining, by the server, real-time weather information for each location from the other server; obtaining, by the server, real-time location information from the first terminal; matching, by the server, the real-time weather information for each location corresponding to the real-time location information; and updating, by the server, the virtual object based on a matching result.

Additionally, the control method for the present disclosure may further include: transmitting, by the first terminal, an object information update request for each location to the server; obtaining, by the server, pre-registered clothing information corresponding to the real-time location information; and updating, by the server, the virtual object based on the clothing information.

Additionally, the control method for the present disclosure may further include: obtaining, by the server, age information and gender information based on the user information; obtaining, by the server, difficulty information based on the age information; obtaining, by the server, interest topic information based on the gender information; obtaining, by the server, first history stage information corresponding to the difficulty information to the first terminal as recommendation information; and obtaining, by the server, education data corresponding to the interest topic information.

Preferably, the outputting of at least one of history contents, the background image, and the virtual object corresponding to the marker may further include: obtaining pre-used first character information based on clear history information; obtaining second character information corresponding to the age information and the gender information from the server; obtaining any one of the first character information, the second character information, and the third character information as the virtual object according to the user command.

Additionally, the control method for the present disclosure may further include: transmitting, by the server, the history stage information to a second terminal corresponding to the first terminal; transmitting, by the server, real-time location information corresponding to the first terminal to the second terminal; transmitting, by the server, access information corresponding to the first terminal to the second terminal; obtaining, by the server, teaching material information corresponding to the stage information to the second terminal; and limiting, by the server, the access of the first terminal, and storing a stage progress history corresponding to the first terminal when the second terminal transmits an access limit request to the first terminal to the server.

1. A control method for a history-based coding education system including a server and a first terminal, comprising:
obtaining, by the first terminal, history stage information corresponding to user information from the server;
obtaining, by the first terminal, an image input through a camera;
identifying, by the first terminal, whether a marker corresponding to the history state information is included in the image; and
outputting, by the first terminal, an augmented reality corresponding to the marker when the marker is included in the image.

2. The control method for claim 1, wherein the outputting of the augmented reality corresponding to the marker comprises:
outputting at least one of history contents, a background image, and a virtual object corresponding to the marker, and
outputting a plurality of blocks corresponding to the background image, and
wherein the control method further comprises:
obtaining, by the first terminal, a user command for at least one block of the plurality of blocks; and
controlling, by the first terminal, a movement of the virtual object based on the user command for the at least one block.

3. The control method for claim 2, wherein the obtaining of, by the first terminal, the user command for at least one block of the plurality of blocks further comprises:
obtaining history information corresponding to the user command for at least one block of the plurality of blocks, and outputting the history information to a predetermined coding area,
identifying whether the history information corresponds to the history stage information, and
deleting the history information and outputting a reinput request message when the history information does not correspond to the history stage information.

4. The control method for claim 3,
wherein the identifying of whether the history information corresponds to the history stage information further comprises obtaining clear information corresponding to the history stage information from the server when the history information corresponds to the history stage information,
wherein the controlling of the movement of the virtual object based on the user command for the at least one block further comprises, outputting the clear information when the virtual object is positioned in a predetermined clear area, and
wherein the clear information is history education data corresponding to the history stage information.

5. The control method for claim 2, further comprising:
transmitting, by the first terminal, location information to the server in real time;
obtaining, by the server, a pre-registered first relic image corresponding to the location information from the first terminal as a marker;
obtaining, by the server, first history stage information corresponding to the first relic image; and
outputting, by the first terminal, an augmented reality corresponding to the first relic image,
wherein the control method further comprises:
transmitting, by the server, hint information corresponding to a second relic image to the first terminal when the first terminal obtains clear information corresponding to the first relic image; and
outputting, by the first terminal, the hint information, and
wherein the hint information includes an obtained point coordinate of the second relic image and a 3D relic image rotatable by the user command for the first terminal.

6. The control method for claim 2, further comprising:
transmitting, by the first terminal, an object information update request for each weather to the server;
obtaining, by the server, real-time weather information for each location from the other server;
obtaining, by the server, real-time location information from the first terminal;
matching, by the server, the real-time weather information for each location corresponding to the real-time location information; and
updating, by the server, the virtual object based on a matching result, and
wherein the control method further comprises:
transmitting, by the first terminal, an object information update request for each location to the server;
obtaining, by the server, pre-registered clothing information corresponding to the real-time location information; and
updating, by the server, the virtual object based on the clothing information.

7. The control method for claim 2, further comprising:
obtaining, by the server, age information and gender information based on the user information;
obtaining, by the server, difficulty information based on the age information;
obtaining, by the server, interest topic information based on the gender information;
obtaining, by the server, first history stage information corresponding to the difficulty information to the first terminal as recommendation information; and
obtaining, by the server, education data corresponding to the interest topic information.

8. The control method for claim 7, wherein the outputting of at least one of history contents, the background image, and the virtual object corresponding to the marker further comprises:
obtaining pre-used first character information based on clear history information;
obtaining second character information corresponding to the age information and the gender information from the server;
obtaining new registered third character information from the server; and
obtaining any one of the first character information, the second character information, and the third character information as the virtual object according to the user command.

9. The control method for claim 1, further comprising:
transmitting, by the server, the history stage information to a second terminal corresponding to the first terminal;
transmitting, by the server, real-time location information corresponding to the first terminal to the second terminal;
transmitting, by the server, access information corresponding to the first terminal to the second terminal;
obtaining, by the server, teaching material information corresponding to the stage information to the second terminal; and
limiting, by the server, the access of the first terminal, and storing a stage progress history corresponding to the first terminal when the second terminal transmits an access limit request to the first terminal to the server.
